(19) United States
(12) Patent Application Publication
(10) Pub. No.: US 2007/0277362 A1
(43) Pub. Date: Dec. 6, 2007

(54) Spindle Structure

(76) Inventor: Lin-Chien Yu, Taoyuan (TW)

Correspondence Address: THEODORE LAPUS;LAW OFFICES OF LAI & ASSOCIATES, P.C., STE 200, 5800 RANCHESTER, HOUSTON, TX, 77036, US

(21) Appl. No.: 11/692,157

(22) Filed: Mar. 27, 2007

(30) Foreign Application Priority Data
Jun. 4, 2006 (TW) 0951125262

(51) Int. Cl. B23P 11/00

(52) U.S. Cl. 29/434

(57) ABSTRACT

A spindle structure is applied for a fastening base of a portable electronic apparatus. The spindle structure includes a fastening rack, a wedge, an elastic body, a holder, a bolt and a stem. The top of the fastening rack is connected to the fastening base. The bottom of the fastening rack is a slide surface in arc shape. The wedge is for clamping the slide surface of the fastening rack. The elastic body provides pressures while clamping the slide surface. The top of the holder has a sleeve which corresponds to the slide surface. The bolt is connected to the elastic body, the wedge and the slide surface. The top of the bolt has a protrusion. The stem is connected by a stem bolt to the bolt. The bolt then is moved by pressing the stem. The elastic body, the wedge and the slide surface are tightened by the protrusion.

### FIELD OF THE INVENTION

The present invention generally relates to a spindle structure, and more specifically relates to the spindle structure that uses a slide surface of a fastening rack to adjust the spindle angle.

### BACKGROUND OF THE INVENTION

When technology is developed gradually, various information products are successively presented to the public, thereby improving our daily life substantially. In the information products, portable electronic products further improve our mobile life.

When a user uses a portable electronic apparatus in a vehicle or other transportations, a fastening base is often used to fasten the portable electronic apparatus. However, the spindle structure of the fastening base in the prior art is immovable. For instance, the spindle angle of the fastening base taught in Taiwan Patent No. 087216985 and No. 085211592 may not be adjusted in the light of user's demands resulting in inconvenience.

To overcome the foregoing shortcomings, the inventor of the present invention based on years of experience in the related field from conducting extensive research and experiments invents a spindle structure as a method or a basis for achieving the aforementioned object.

### SUMMARY OF THE INVENTION

Briefly, it is an objective of the invention to provide a spindle structure. More specifically, the spindle angle of the spindle structure can be adjusted by using a slide surface of a fastening rack.

To achieve of the foregoing objective, the spindle structure of the invention is applied to a fastening base of a portable electronic apparatus. The spindle structure comprises a fastening rack, a clamp, an elastic body, a holder, a bolt and a stem. The fastening rack is connected to the fixing base from the top. The bottom of the fastening rack has a slide surface in arc shape. The wedge is used to tighten the slide surface of the fastening rack. The elastic body provides pressures while tightening the slide surface. The top of the holder has a sleeve corresponding to the slide surface. The bolt is used to connect the elastic body, the wedge and the slide surface. Moreover, the top of the bolt has a protrusion for tightening the elastic body, the wedge and the slide surface. The stem is connected to the bolt through a stem bolt, wherein the blot is moved by rotationally pressing the stem. The elastic body, the wedge and the slide surface then are tightened through the protrusion.

When the fastening rack of the spindle structure has the slide surface and when the wedge is assembled by the bolt to the elastic body, the damping slide then is generated to conveniently adjust the spindle angle through the pressures provided by the elastic body.

To make it easier for our examiner to understand the objective of the invention, its innovative features and performance, a detailed description and technical characteristics of the present invention are described together with the drawings as follows.

### BRIEF DESCRIPTION OF THE DRAWINGS

FIG. 1 is an exploded assembly drawing of a spindle structure of the invention;

FIG. 2 is a top view of a spindle structure of the invention;

FIG. 3 is a cross-section drawing of a spindle structure of the invention;

FIG. 4 is another top view of a spindle structure of the invention;

FIG. 5 is a cross-section drawing of a spindle structure under loosening of the invention; and

FIG. 6 is a cross-section drawing of a spindle structure under tightening condition of the invention.

### DETAILED DESCRIPTION OF THE PREFERRED EMBODIMENTS

Referring to the related figures for the spindle structure according to a preferred embodiment of the present invention, wherein the same elements are described by the same reference numerals.

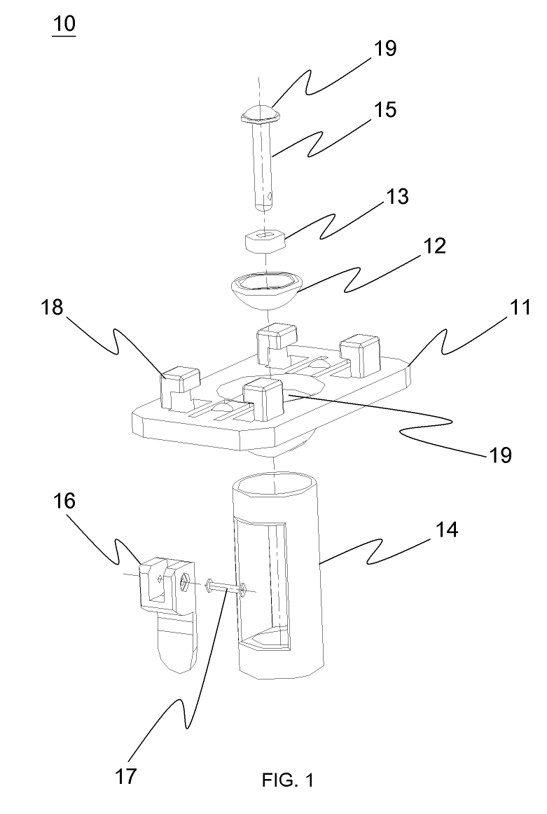

Referring to FIG. 1 for the exploded assembly drawing of a spindle structure of the invention, the spindle structure 10 comprises a fastening rack, 11, a wedge 12, an elastic body 13, a holder 14, a bolt 15 and a stem 16. The fastening rack 11 is connected to a fastening base from the top and the bottom of the fastening rack 11 has a slide surface 19 in arc shape. The wedge 12 is used to tighten the slide surface 19 of the fastening rack 11. The elastic body 13 provides pressures while tightening the slide surface 19. The top of the holder 14 has a sleeve 141 corresponding to the slide surface 19. The bolt 15 is used to connect the elastic body 13, the wedge 12 and the slide surface 19. Moreover, the top of the bolt 15 has a protrusion 18 for tightening the elastic body 13, the wedge 12 and the slide surface 19. The stem 16 is connected to the bolt 15 through the stem bolt 17. The bolt 15 can be moved by rotationally pressing the stem 16. The elastic body 13, the wedge 12 and the slide surface 19 are tightened through the protrusion 18. The elastic body 13 is preferably a rubber.

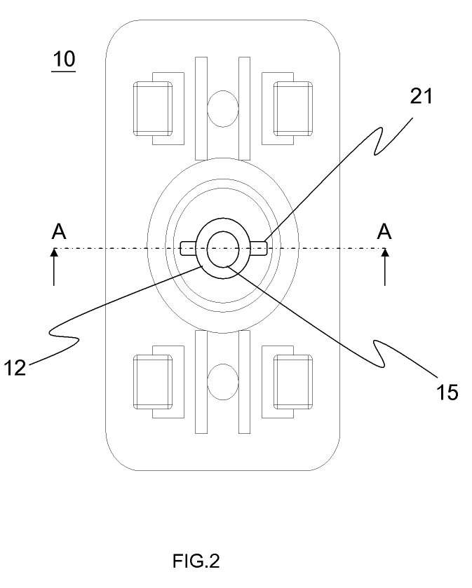

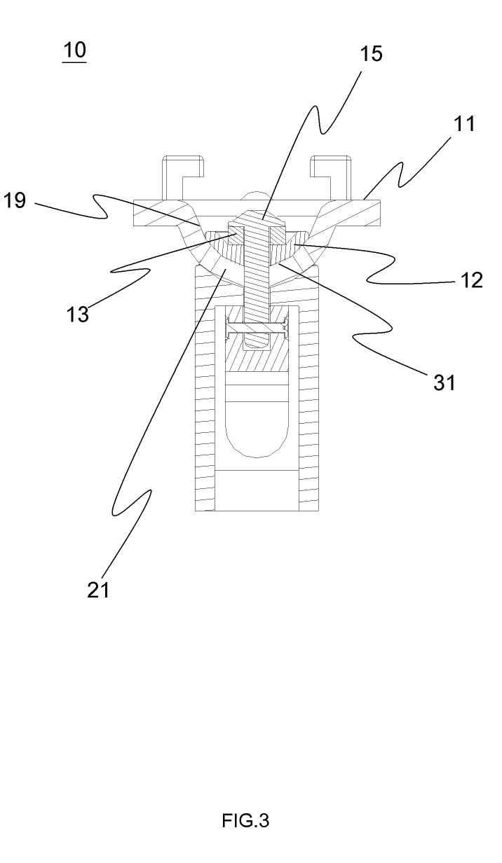

Referring to FIG. 2 and FIG. 3, FIG. 2 is a top view of a spindle structure of the invention and FIG. 3 is a cross-section drawing of a spindle structure of the invention, wherein the line segment AA shown in FIG. 2 is taken as the section for the cross-section illustrated in FIG. 3, hence the inside of the spindle structure 10 can be clearly seen. The wedge 12 of the spindle structure 10 further comprises a clamp surface 31 that is a contact surface disposed between the wedge 12 and the slide surface 19. The clamp surface 31 and the slide surface 19 generate the damping slide through the pressures provided by the elastic body 13. A slide notch 21 is on the slide surface 19, and when the clamp surface 31 and the slide surface 19 generate the damping slide, the slide notch 21 is moved relative to the bolt 15 to adjust the spindle angle of the fastening rack 11.

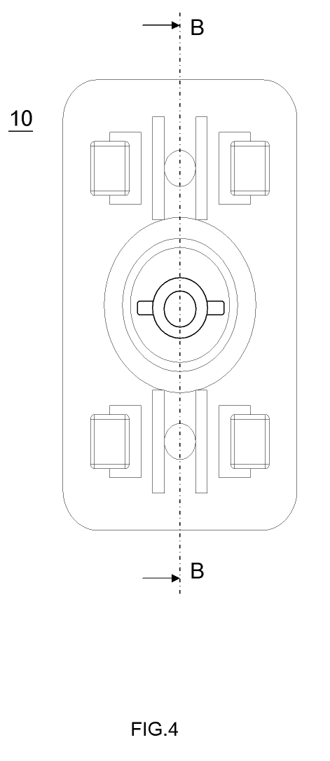

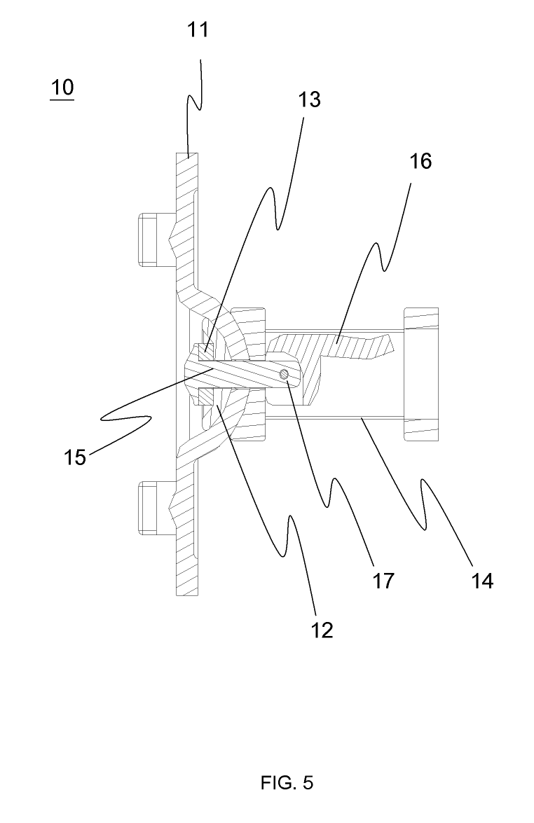

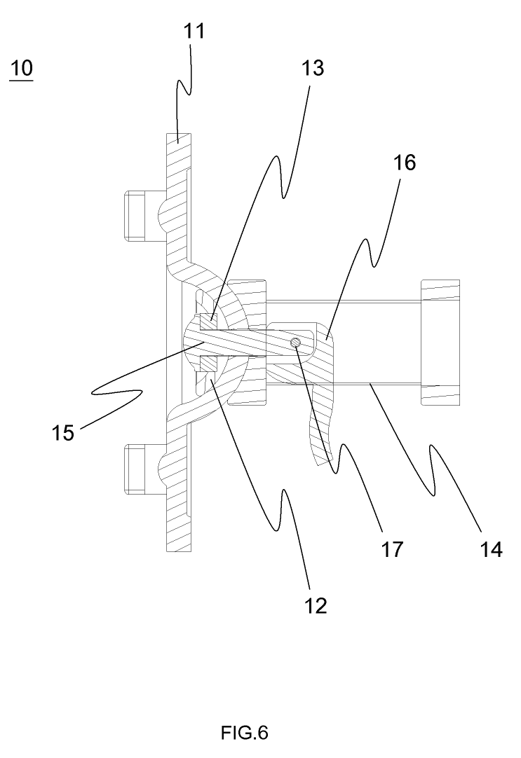

Referring to FIG. 4, FIG. 5 and FIG. 6, FIG. 4 is another top view of a spindle structure of the invention, FIG. 5 is a cross-section drawing of a spindle structure under loosing of the invention, and FIG. 6 is a cross-section drawing of a spindle structure under tightening condition of the invention. The line segment BB shown in FIG. 4 is taken as the section for the cross-sections illustrated in FIG. 5 and FIG. 6, hence the inside of the spindle structure 10 can be clearly seen. The spindle structure 10 comprises the stem 16, the stem bolt 17, the bolt 15, the elastic body 13, the wedge 12, the fastening rack 11 and the holder 14. The stem 16 parallels the holder 14 as shown in FIG. 5 when the stem 16 is under loosening. A support edge of the stem 16 is driven to become a longer edge from a shorter edge when the stem 16 is rotationally pressed. The bolt 15 then is tightened by the stem bolt 17 to allow the bolt 15 to tighten the elastic body 13, the wedge 12, the fastening rack 11 and the holder 14. Accordingly, the stem 16 is vertical to the holder 14 as shown in FIG. 6

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A spindle structure for a fastening base of a portable electronic apparatus, said spindle structure comprising:
a fastening rack connected to said fastening base from the top, the bottom of said fastening rack having a slide surface in arc shape;
a clamp for tightening said slide surface of said fastening rack;
an elastic body for providing pressures while tightening said slide surface;
a holder, the top of said holder having a sleeve corresponding to said slide surface;
a bolt connected to said elastic body, said wedge and said slide surface, and the top of said bolt having a protrusion; and
a stem having a stem bolt for connecting said bolt;
wherein said bolt is moved by rotationally pressing said elastic body, and said elastic body, said wedge and said slide surface are tightened through said protrusion.

2. The spindle structure of claim 1, wherein said wedge further comprises a clamp surface, and said clamp surface is a contact surface disposed between said wedge and said slide surface.

3. The spindle structure of claim 2, wherein said clamp surface and said slide surface generate the damping slide through pressures provided by said elastic body.

4. The spindle structure of claim 3, wherein the spindle structure further comprises a slide notch that is on said slide surface, and when said clamp surface and said slide surface generate the damping slide, said slide notch is moved relative to said bolt to adjust the spindle angle of said fastening rack.

5. The spindle structure of claim 1, wherein a support edge of said stem is driven to become a longer edge from a shorter edge when said stem is rotationally pressed, and said bolt is tightened by said stem bolt.

6. The spindle structure of claim 1, wherein said elastic body is a rubber.
